(19) United States
(12) Patent Application Publication
(10) Pub. No.: US 2006/0048158 A1
(43) Pub. Date: Mar. 2, 2006

(54) Methods and apparatus for aging a command

(75) Inventor: Glen H. Handlogten, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/901,597

(22) Filed: Jul. 29, 2004

(51) Int. Cl. G06F 9/46

(52) U.S. Cl. 718/104

(57) ABSTRACT

In a first aspect, a first method is provided for servicing a command. The first method includes the steps of (1) accessing an activity count corresponding to a command selected for servicing, wherein the activity count indicates a number of times the command has been selected for servicing; (2) based on the activity count, updating a blocking threshold value; and (3) determining whether to service the command based on the activity count and the blocking threshold value. Numerous other aspects are provided.

### CROSS REFERENCE TO RELATED APPLICATION

The present application is related to U.S. patent application Ser. No. ______, filed ______ and titled “RESOURCE ALLOCATION MANAGEMENT” (Attorney Docket No. ROC920040051), which is hereby incorporated by reference herein in its entirety.

### FIELD OF THE INVENTION

The present invention relates generally to computer systems, and more particularly to methods and apparatus for aging a command within a computer system.

### BACKGROUND

A computer system (e.g., a computer system made up of multiple processing units) may receive commands which require resources of the computer system. In many conventional computer systems, system resources may be allocated to commands on a first-come first-served basis. However, such an allocation scheme may not efficiently manage the system resources. Accordingly, improved methods and apparatus are desired for managing system resource allocation.

### SUMMARY OF THE INVENTION

In a first aspect of the invention, a first method is provided for servicing a command. The first method includes the steps of (1) accessing an activity count corresponding to a command selected for servicing, wherein the activity count indicates a number of times the command has been selected for servicing; (2) based on the activity count, updating a blocking threshold value; and (3) determining whether to service the command based on the activity count and the blocking threshold value.

In a second aspect of the invention, a first apparatus is provided for servicing a command. The first apparatus includes aging logic adapted to (1) access an activity count corresponding to a command selected for servicing, wherein the activity count indicates a number of times the command has been selected for servicing; (2) based on the activity count, update a blocking threshold value; and (3) determine whether to service the command based on the activity count and the blocking threshold value. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of an apparatus for aging commands in accordance with an embodiment of the present invention.

FIG. 2 illustrates a first exemplary method for aging commands in accordance with an embodiment of the present invention.

FIG. 3 is a block diagram of an apparatus for managing system resource allocation, which includes an apparatus for aging commands, in accordance with an embodiment of the present invention.

FIG. 4 illustrates a second exemplary method for aging commands in accordance with an embodiment of the present invention.

FIG. 5 is a timing diagram illustrating operation of an apparatus for aging commands.

### DETAILED DESCRIPTION

A computer system may receive a first command requiring service. However, for example, while employing certain performance-enhancing techniques, such as token borrowing, which is described in copending U.S. patent application Ser. No. ______, filed ______ and titled “RESOURCE ALLOCATION MANAGEMENT” (Attorney Docket No. ROC920040051), which is hereby incorporated by reference herein in its entirety, the computer system may choose to service other commands, which are received before and/or after the first command, before the first command is serviced. Therefore, in certain situations, the computer system may not service the first command for a long time, which may result in performance problems. The present invention provides methods and apparatus to efficiently and more consistently service commands. More specifically, the present methods and apparatus “age” a command received but not executed by the computer system, and service the command based on the age. As the command increases in age, the computer system may favor (e.g., increasingly favor) the command while selecting a next command for servicing. For example, the computer system may employ a graduated scale for favoring the command. Therefore, the effects of aging are graduated. In this manner, the present methods and apparatus may avoid the performance problems described above.

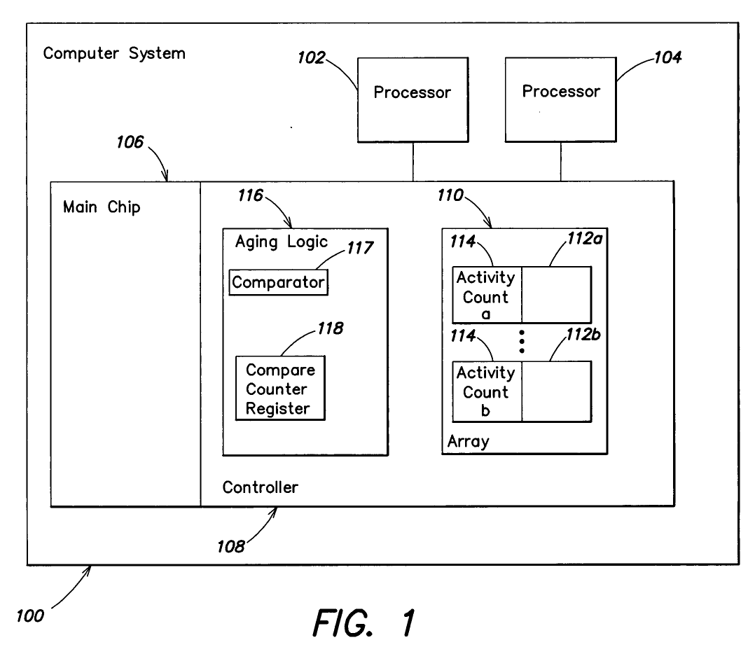

FIG. 1 is a block diagram of an apparatus for aging commands in accordance with an embodiment of the present invention. The apparatus 100 is a computer system that includes one or more processors 102-104 coupled to and/or included in a main chip 106. The one or more processors 102-104 may issue commands for the main chip 106. The main chip 106 is coupled to a controller 108, which may couple the main chip 106 to the one or more processors 102-104. The main chip 106 may receive commands from the one or more processors 102-104 or another component of the main chip 106 via the controller 108. The controller 108 includes an array 110 for storing an entry 112a-b corresponding to each of one or more received commands. The apparatus 100 examines (e.g., scans) the array entries to determine commands that may be serviced. More specifically, during a first time period (e.g., a first processor cycle), the apparatus 100 may access a first array entry 112a to determine whether the command corresponding to the first array entry 112a may be serviced. During a next time period (e.g., a second processor cycle), the apparatus 100 may access a second array entry 112b to determine whether the command corresponding to the second array entry 112b may be serviced. Similarly, the apparatus 110 scans the remaining array entries during subsequent time periods. If the apparatus 100 accesses the last array entry during a time period, during the next time period, the apparatus 100 accesses the first array entry 112a.

Each entry 112 corresponding to a received command includes an activity count 114 indicating the number of times the command has been examined (e.g., scanned) for potential service since being received by the apparatus 100. In one embodiment, the activity count includes eight bits. Therefore, the value of the activity count may be 0-255. A larger or smaller number of bits may be employed for the activity count. The activity count may indicate the “age” of a command received by the apparatus 100. More specifically, the larger the activity count value, the longer (e.g., measured in time periods) the command has waited for servicing. The longer the command has waited for servicing, the older the command.

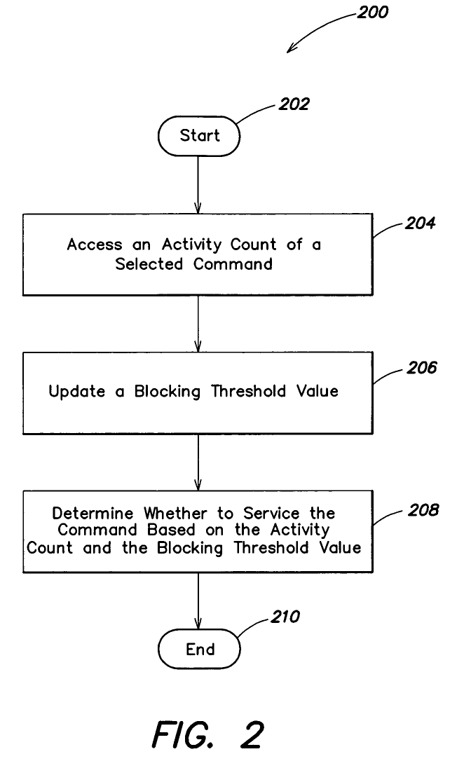

Aging logic 116 for efficiently servicing one or more commands received by the apparatus 100 is coupled to the controller 108. The aging logic 116 may include any suitable combination of logic, registers, memory or the like, and in at least one embodiment may comprise an application specific integrated circuit (ASIC). For example, the aging logic 116 includes a counter register (e.g., compare counter register) 118 for storing a value upon which a blocking threshold value is based. As described below with reference to FIG. 2, the apparatus 100 determines whether to service or not service (e.g., block) a command based, in part, on the blocking threshold value. Further, the aging logic 116 may include a comparator 117 for comparing a value stored in the compare counter register 118 with an activity count.

The operation of the apparatus 100 for aging a command is now described with reference to FIG. 1, and with reference to FIG. 2, which illustrates a first exemplary method for aging commands in accordance with an embodiment of the present invention. More specifically, FIG. 2 illustrates a method for servicing a command based on the activity count included in the command, and therefore the age of the command. With reference to FIG. 2, in step 202, the method 200 begins. In step 204, an activity count corresponding to a command selected for servicing is accessed. The activity count indicates a number of times the command has been examined for potential service (e.g., selected for servicing). For example, the activity count may indicate a number of times the command has been selected for servicing without completing. A command completes once the command obtains all required tokens (e.g., obtains permission to use all required system resources). More specifically, during a time period (e.g., a first processor cycle), the apparatus 100 may select a command for servicing. The aging logic 116 of the apparatus 100 may access the activity count 114 corresponding to the command received by the apparatus 100. In one embodiment, the maximum activity count value is 255. Therefore, even if a command is selected for servicing more than 255 times, the activity count remains at 255. Further, the activity count of a new command received by the computer system is initialized to 0.

In step 206, based on the activity count, a blocking threshold value is updated. More specifically, a value stored in the compare counter register 118 of the aging logic 116 is updated. In one embodiment, the compare counter register 118 may store values (e.g., binary values) of 16, 32, 64, 128 or 256. Such potential compare counter register values correspond to activity count thresholds. It should be noted that the potential compare counter register values are increased in graduated increments. Different and/or additional values may be employed for the activity count threshold, and therefore, the compare counter register 118 may store additional and/or different values.

More specifically, in step 206, the aging logic 116 updates the value stored in the compare counter register based on the activity count of the selected command. For example, if the activity count value of the selected command is greater than or equal to 16, but less than 32 and the compare counter register value is less than or equal to 16, the compare counter register value is updated to 16. Further, (1) if the activity count value of the selected command is greater than or equal to 32, but less than 64 and the compare counter register value is less than or equal to 32, the compare counter register value is updated to 32; (2) if the activity count value of the selected command is greater than or equal to 64, but less than 128 and the compare counter register value is less than or equal to 64, the compare counter register value is updated to 64; (3) if the activity count value of the selected command is greater than or equal to 128, but less than 255 and the compare counter register value is less than or equal to 128, the compare counter register value is updated to 128; and (4) if the activity count value of the selected command is equal to 255, the compare counter register value is updated to 256. Logic, such as the comparator 117, may be employed to perform the above comparisons. In this manner, the compare counter register value is incremented when the activity count of a selected command initially increases to (or past) one or more activity count thresholds (e.g., 16, 32, 64, 128 or 255), for example, after the compare counter register value was reset. The compare counter register value is reset to 0 when the apparatus 100 frees any command (e.g., the command obtains all required system resources).

The aging logic 116 is adapted to compute the blocking threshold value based on the compare counter register value. In one embodiment, the blocking threshold value is one-half the value stored in the compare counter register 118. In other embodiments, the relationship between the blocking threshold value and the compare counter register value may be different (e.g., the blocking threshold value is three-fourths the value stored in the compare counter register 118). In such embodiments, the aging logic 116 is modified accordingly to make the necessary computation. Such a modification is known to one of ordinary skill in art. Because the blocking threshold value is related to the compare counter register value, by updating the compare counter register value, the aging logic 116 updates the blocking threshold value. As described further below, the aging logic 116 employs the blocking threshold value, in part, to determine whether or not to service a command (e.g., the selected command).

In step 208, it is determined whether to service the command based on the activity count and the blocking threshold value. More specifically, the aging logic 116 determines whether to service the command based on the activity count and the blocking threshold value. For example, if the activity count is greater than or equal to the blocking threshold value, the aging logic 116 allows the apparatus 100 to service the selected command. However, if the activity count is less than the blocking threshold value, the aging logic 116 does not service (e.g., blocks) the selected command. The aging logic 116 determines whether to service the command based, in part, on the activity count, which indicates the age of the command. Therefore, the aging logic 116 determines whether to service the command based on the age of the command. Thereafter, step 210 is performed. In step 210, the method 200 ends.

Additionally, the apparatus 100 may select another command for servicing, for example, during a subsequent time period. The method 200 may be performed on the selected command as described above.

Through the use of the method 200 of FIG. 2, commands may be serviced efficiently. More specifically, when an age of a command received by the apparatus 100 increases to a first threshold (e.g., an activity count threshold), the aging logic 116 may block one or more commands of an age below a second threshold (e.g. a blocking threshold count) and service one or more commands of an age greater than or equal to the second threshold. In this manner, one or more older commands may be serviced before (e.g., favored over) commands which are not as old (e.g., younger commands).

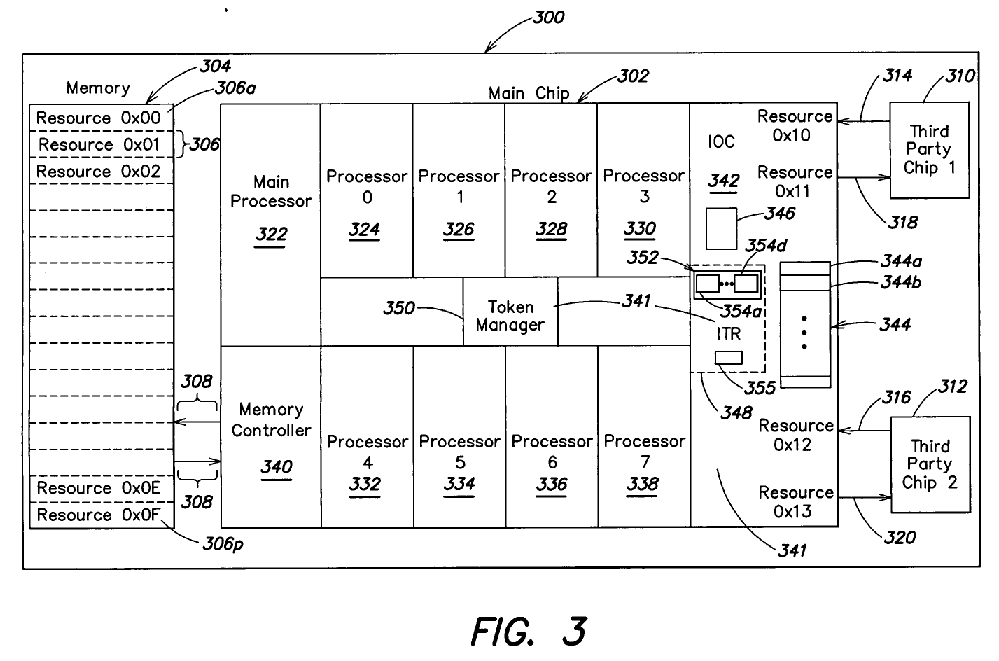

The present methods and apparatus may be implemented by any apparatus, which must process a list of work or tasks, thereby enabling the apparatus to efficiently process the list. For example, the present methods and apparatus may be implemented in an apparatus for managing system resource allocation. FIG. 3 is a block diagram of an apparatus for managing system resource allocation, which includes an apparatus for aging commands, in accordance with an embodiment of the present invention. The apparatus 300 of FIG. 3 is similar to the apparatus 100 of copending application Ser. No. ______ (Attorney Docket No. ROC920040051). The apparatus 300 is a computer system that includes a main chip 302, which is described below, coupled to a memory 304, such as a system memory. The memory 304 may be divided into a plurality of sections (e.g., memory banks 306a-p). In one embodiment, the memory 304 is divided into sixteen memory banks 306a-p. The memory 304 may be divided into a larger or smaller number of memory banks 306a-p. Each of the memory banks 306a-p serves as a system resource. The main chip 302 is coupled to the memory 304 via a memory bus 308, which provides a bandwidth (e.g., memory bus bandwidth) that may be used to access the memory banks 306a-p, for example, in response to a command received by the computer system.

The main chip 302 is coupled to one or more chips (e.g., third party chips 310-312), which may issue commands for the main chip 302. In one embodiment, two third party chips 310-312 are coupled to the main chip 302. Other numbers of third party chips 310-312 may be coupled to main chip 302. The main chip 302 is coupled to the third party chips 310-312 via I/O interfaces (IOIFs), such as respective inbound 314-316 and outbound buses 318-320 (e.g., I/O buses). The respective inbound 314-316 and outbound buses 318-320 coupled to the third party chips 310-312 serve as system resources. Each of the inbound 314-316 and outbound buses 318-320 provides a bandwidth (e.g., I/O bus bandwidth) that may be used for communication between one of the third party chips 310-312 and other components coupled to the main chip 302. Therefore, the apparatus 300 includes system resources, such as memory banks 306a-p and I/O interfaces.

The main chip 302 includes a plurality of processors, such as a main processor 322 and eight co-processors 324-338. The main chip 302 may include a larger or smaller number of main processors 322 and/or co-processors 324-338. Components of the main chip 302, such as the processors 322-338, may require, and therefore, request access to one or more system resources. The main chip 302 includes a memory controller 340 that serves as an interface to the memory 304. Alternatively, the main chip 302 may not include a memory controller 340.

Further, the main chip 302 includes and/or is coupled to a plurality of logic 341 adapted to manage allocation of the system resources. More specifically, the plurality of logic 341 implements Resource Allocation Management (RAM) that provides an access control mechanism for allocating one or more portions of a system resource to one or more components which request the system resource. The plurality of logic 341 may associate a token with each system resource. RAM may require a command residing in a component of the computer system, such as one of the main chip processors 322-338 or the third party processors 310-312, which requires a system resource, to request and acquire (e.g., be granted) a token corresponding to the system resource before using the system resource. In a first set of embodiments of the present invention, a token requested for a first command residing in a component 310-312, 322-338 of the computer system 300 may not be requested for a second command residing in the component 310-312, 322-338 until the token is granted to the first command residing in the component 310-312, 322-338.

As described below, a second set of embodiments of the present invention may not require a token requested for a first command residing in the component 310-312, 322-338 to be granted to the requesting command before a second command residing in the component 310-312, 322-338 may request the token. In such embodiments, the token requested for the first command residing in the component 310-312, 322-338 may be granted to (e.g., borrowed by) the second command residing in the component 310-312, 322-338. Therefore, in the second set of embodiments, when a token is granted to a component 310-312, 322-338, the token may be assigned to any command, which requires the token, residing in the component 310-312, 322-338. More specifically, the token does not have to be assigned to the command for which the request was originally made. Thereafter, another command residing in the component 310-312, 322-338 of the computer system may request the token. Therefore, the first command may be unable to obtain the token for a very long time. Consequently, the apparatus 300 may experience performance problems.

In either set of embodiments, a token requested by a component 310-312, 322-338 may not be requested again by the component 310-312, 322-338 until the token has been granted to that component 310-312, 322-338. Components 310-312, 322-338 may not have and may not need any knowledge of token requests made by other components 310-312, 322-338 of the computer system. Therefore, there may be multiple requests for a particular token, but only one per component 310-312, 322-338. Further, each component 310-312, 322-338 is allowed a single outstanding request per token type (e.g., per each token corresponding to a system resource).

As will be described below, commands, which require tokens, originating from third party chips 310-312 may be combined in a single component that requests the required tokens. Therefore, in the second set of embodiments, requests for such commands may be deemed as for a single component, and tokens granted to the single component may be assigned to any command from any (e.g., either) third party chip 310-312.

The plurality of logic 341 includes an input/output controller (IOC) 342 coupled to the inbound 314-316 and outbound buses 318-320. The IOC 342 includes an array 344, which includes a plurality of entries, and a plurality of registers 346 or similar devices, each of which is adapted to store an index corresponding to an array entry. In one embodiment, the IOC 342 serves as a proxy for one or more components coupled to the main chip (e.g., third party chips 310-312). More specifically, the IOC 342 receives commands from a third party chip 310-312 and includes the third party chip command in the main chip 302. In this manner, commands from components (e.g., commands from third party chips 310-312) are combined in the IOC 342 and resources are requested for such commands by the IOC 342. The IOC 342 is adapted to manage the indexes stored in the plurality of registers 346 and associate an unused index with a command received by the IOC 342 from a component 310-312, 322-338. The received command is stored in the array entry indicated by the index with which the command is associated. In one embodiment, the array 344 includes sixty-four entries. Therefore, the IOC 342 may receive and store up to sixty-four commands (e.g., up to sixty-four commands are “in flight”). The array 344 may include more or less entries, and therefore, the IOC 342 may receive and store more or less commands. Each of the commands may require up to three system resources (e.g., tokens corresponding to system resources). Each array entry includes an activity count field for storing an activity count of the command corresponding to the array entry. The activity count may include eight bits. The activity count may include a larger or smaller number of bits.

In one or more embodiments, components 310-312, 322-338 of the apparatus 300, and therefore, commands from the components 310-312, 322-338, are grouped together to form one or more Resource Allocation Groups (RAGs), each of which is assigned a Resource Allocation ID (RAID). The plurality of logic 341 may allocate system resources to commands received from components 310-312, 322-338 in a RAG based on the RAID assigned to the RAG. More specifically, processes with one RAID may be allocated system resources more frequently than processes with other RAIDs. In this manner, the RAID associated with each RAG serves as a priority for the RAG.

The plurality of logic 341 includes IOC Token Requester logic (ITR) 348 coupled to the main chip 302. The IOC 342 may include the ITR 348. The ITR 348 is adapted to efficiently request tokens required by commands received by the IOC 342. A request to obtain a token for a command is passed in the form of an index, which is used to obtain information about the command stored in the array 344. The ITR 348 receives an index and makes a read request to the array 344. In this manner, the ITR 348 may free indexes corresponding to commands. An index associated with a command is freed (e.g., available) once all tokens required by the command are granted to the command and all required token requests are made for the command. The index may not be associated with another command until the index is freed. Further, the ITR 348 is adapted to receive a granted token and efficiently assign the granted token to a command which requires the token. In this manner, the ITR 348 may free commands. A command is freed from (e.g., may exit) the IOC 342 (e.g., ITR 148) once all tokens required by the command are granted. The ITR 348 updates the array entry corresponding to a command, for example, after requesting a token for the command or granting a token to the command.

The plurality of logic 341 includes Token Manager logic (TM) 350 coupled to the IOC 342. The TM 350 is adapted to generate a token corresponding to one or more system resources. A user may configure the TM 350 to generate a token corresponding to a system resource based on a specified period for the resource. For example, the TM 350 may initially create the token corresponding to the system resource in a time based on the specified period. Therefore, the order in which the requested token is granted to may not be predictable (e.g., by a requester). Once the token is granted, the TM 350 may create a new token for the system resource based on the specified period. Further, the TM 350 is adapted to receive a request for a token, which corresponds to a system resource, from the ITR 348. In one embodiment, the apparatus 300 includes twenty system resources (e.g., the sixteen memory banks 306a-p and two inbound 314-316 and two outbound I/O buses 318-320). Therefore, the TM 350 creates twenty tokens for each RAG. In other embodiments, the apparatus 300 may include more or less system resources and, therefore, the TM 350 may create more or less tokens.

In contrast to the apparatus 100 of copending application Ser. No. ______ (Attorney Docket No. ROC920040051), and to avoid performance problems, the apparatus 300 includes aging logic 352 for efficiently and more consistently servicing one or more commands received by the apparatus 300. The aging logic 116 is coupled to the plurality of logic 341 and may be included in the ITR 348. The aging logic 352 is similar to the aging logic 116 described above with reference to FIG. 1. For example, the aging logic 352 includes a counter register (e.g., compare counter register) 354 and a comparator 355. For embodiments in which components 310-312, 322-338 of the apparatus 300, and therefore, commands from the components 310-312, 322-338, are grouped together to form one or more Resource Allocation Groups (RAGs), the aging logic 352 may include a counter register 354a-d corresponding to each RAG. Each counter register stores a value upon which a blocking threshold value is based for the respective RAG. In this manner, the present methods and apparatus may be included in an apparatus for managing system resource allocation that implements RAM and/or allows token borrowing.

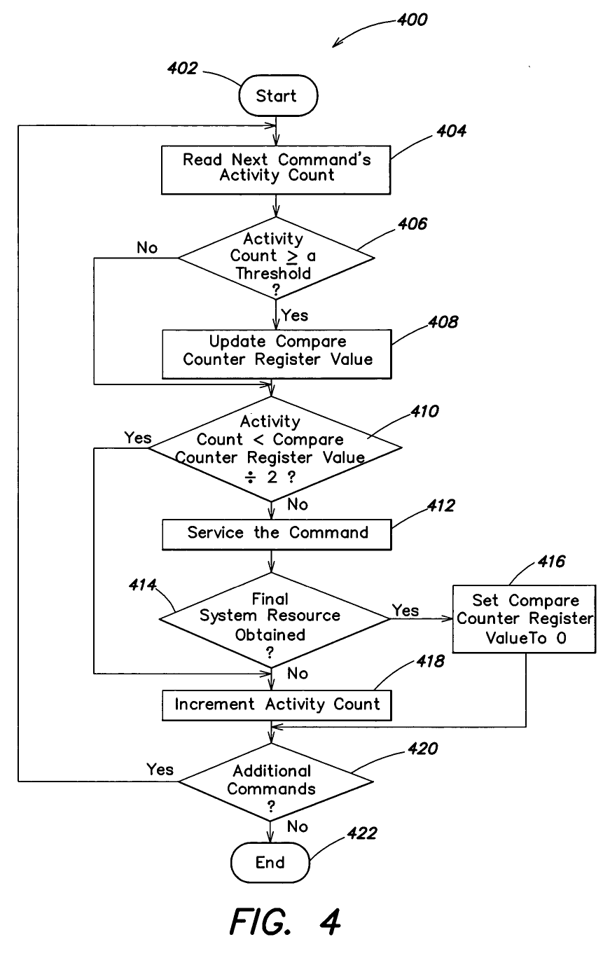

The operation of the apparatus 300 for aging a command is now described with reference to FIG. 3, and with reference to FIG. 4, which illustrates a second exemplary method for aging commands in accordance with an embodiment of the present invention. More specifically, FIG. 4 illustrates a method for servicing a command based on the age of the command in a system that implements token borrowing. With reference to FIG. 4, in step 402, the method 400 begins. In step 404, an activity count corresponding to a command selected for servicing is accessed. For example, the ITR 348 may access the activity count corresponding to the command selected for servicing, in the manner similar to the apparatus 100 described above.

In step 406, it is determined whether the activity count corresponding to the selected command is greater than or equal to a threshold (e.g. an activity count threshold). More specifically, the aging logic 352 compares the activity count corresponding to the selected command with the activity count thresholds (e.g., 16, 32, 64, 128 and 255). Different and/or additional activity count thresholds may be employed. The aging logic 352 includes logic suitable to perform such a comparison. More specifically, the aging logic 352 compares the activity count value with the activity count thresholds to determine if the activity count initially increases to an activity count threshold (e.g., 16, 32, 64, 128 or 255), for example, after a compare counter register value was reset. If the activity count does initially increase to an activity count threshold after the compare counter register value was reset, step 408 is performed.

In step 408, the compare count value is updated. Similar to step 206 of the method 200, a value stored in the compare counter register 354 of the aging logic 352 is updated. Thereafter, step 410 is performed.

Alternatively, in step 406, if the activity count does not initially increase to an activity count threshold after the compare counter register value was reset, step 410 is performed.

In step 410, it is determined whether the activity count corresponding to the selected command is less than one-half of a value (e.g., updated value) stored in the compare counter register 354. The aging logic 352 performs a computation to make the above determination. In other embodiments, the aging logic may determine whether the activity count corresponding to the selected command is less than another fraction of the value stored in the compare counter register 354. In such embodiments, the aging logic 352 is modified accordingly. Such a modification is known to one of ordinary skill in art. The fraction of the value stored in the compare counter register 354 corresponds to a blocking threshold value. Therefore, in step 410, the aging logic 352 determines whether the activity count corresponding to the selected command, which indicates the age of a command, is less than a blocking threshold value. If the activity count corresponding to the selected command is less than one-half of the value stored in the compare counter register 354, the age of the command is less than the blocking threshold value, and therefore, step 418 is performed. In this manner, the command is not serviced and thereby prevented from requesting a system resource and/or obtaining a system resource. Consequently, the likelihood of another command (e.g., an older command) subsequently being able to request the system resource and/or obtain the system resource is increased. Alternatively, if the activity count corresponding to the selected command is not less than one-half of the value stored in the compare counter register 354, the age of the command is greater than or equal to the blocking threshold value, and therefore, step 412 is performed.

In step 412, the command selected for servicing is serviced. More specifically, the ITR 348 may determine whether a request for a system resource (e.g., a token corresponding to the system resource) may be made on behalf of the command and/or whether a system resource may be assigned to the command. If so, the ITR 348 requests a system resource on behalf of the command and/or assigns a required system resource to the command. Thereafter, step 414 is performed.

In step 414, it is determined whether the serviced command obtains a final required system resource. More specifically, the aging logic 352 determines whether the command is freed. A command is freed when the command obtains permission to use all system resources required by the command. When a command (in this case a command older than other commands received by the system) is freed, the apparatus 300 for managing system resource allocation is making progress. If the command obtains a final required system resource, step 416 is performed.

In step 416, the value stored in the compare counter register 354 is reset. For example, the value (e.g., binary value) stored in the compare counter register 354 may be set to 0. By resetting the compare counter register value, the effects of aging provided by the aging logic 352 are diminished. More specifically, commands with smaller activity counts (e.g., younger commands) may subsequently be serviced. Because a command was freed (e.g., completed) and the apparatus 300 is making progress, the apparatus 300 may service such younger commands. Thereafter, step 420 is performed. In this manner, newer or younger commands are not serviced until at least one older command is freed (e.g., completes).

Alternatively, in step 414, if the serviced command does not obtain a final required system resource, step 418 is performed. For example, in step 414, the ITR 348 may request a system resource on behalf of the command and/or assign the first of a plurality of required system resources to the command. However, the ITR 348 does not assign the final system resource required by the serviced command. The serviced command does not obtain a final required system resource (e.g., because a token corresponding to such system resource is not yet available), and therefore, is not freed. Consequently, such a command must wait for selection by the ITR 348 in a subsequent time period. Thereafter, step 418 is performed.

In step 418, the activity count for the selected command is incremented. More specifically, the activity count for a command which was not serviced because the activity count was less than one-half of a value stored in the compare counter register 354, or for a command, which was serviced but not freed, is incremented. In one embodiment, the activity count is incremented by one. The activity count may be incremented by a different number. As stated, once the activity count of a command reaches a maximum value (e.g., 255), the activity count may not be incremented. In this manner, a selected command that was not serviced, for example, because the command was too young, or a command, which was serviced but not freed, may age. Therefore, during subsequent time periods (e.g., processor cycles), such commands may be favored over younger commands (e.g., commands that have not yet been received from a third party chip 310-312). The activity counts included in the command continue to increment, and therefore, the commands continue to age until the command completes or includes a maximum activity count value.

In step 420, the apparatus for aging commands determines whether additional commands require servicing. For example, the ITR 348 may scan entries in the array 344 for commands that require servicing. If additional commands require servicing, step 404 is performed. Alternatively, if no additional commands require servicing, step 422 is performed. For example, if the array 344 is empty, no commands require servicing. In step 422, the method 400 ends.

Through the use of the method 400 of FIG. 4, commands may be serviced efficiently in a system that implements token borrowing.

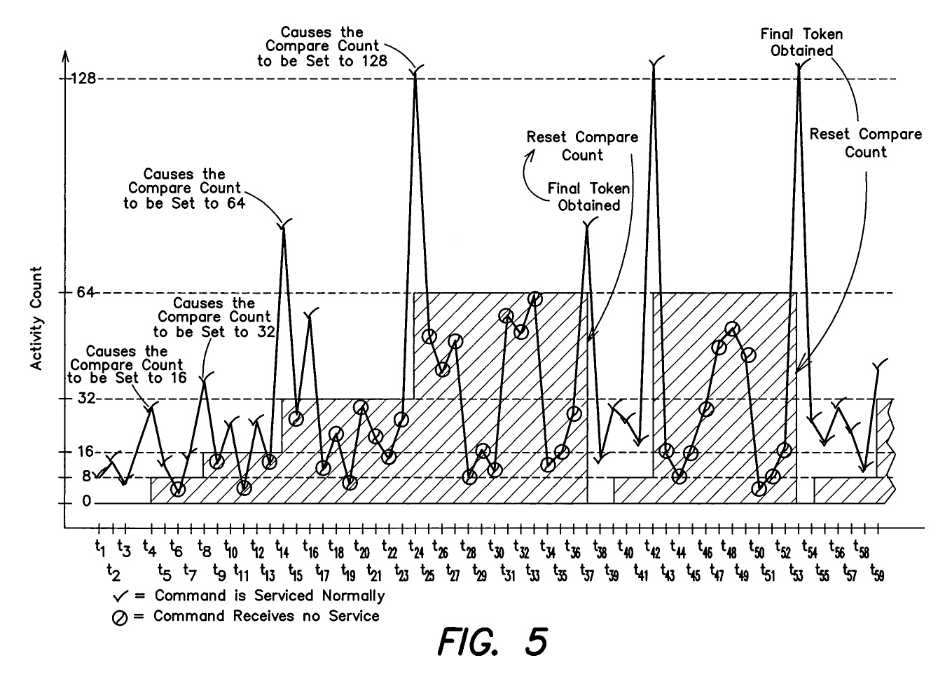

The operation of the apparatus 300 is now described with reference to FIGS. 3-4, and with reference to FIG. 5 which depicts a timing diagram illustrating operation of the apparatus 300 for managing system resource allocation, which includes an apparatus for aging commands. More specifically, FIG. 5 illustrates the method 400 employed on the apparatus 300 over time. The apparatus 300 includes activity count thresholds of 16, 32, 64 and 128. Further, it is assumed that the compare counter register value was reset before time t1. Additionally, unless stated, it is assumed a serviced command did not obtain a final required system resource (e.g., is not freed).

With reference to FIG. 5, during time period t1, the ITR 348 selects a command, which includes an activity count of 8, for servicing. As described in step 406, because the activity count for the command is not greater than or equal to an activity count threshold value (e.g., 16, 32, 64 or 128), the aging logic 352 does not update the compare counter register value. Further, as described in steps 410-412, because the activity count is not less than one-half of the compare counter register value, which is currently 0, the aging logic 352 services the command. Because it is assumed the serviced command is not freed, the activity count for the command is incremented (e.g., by 1). Thereafter, the ITR 348 may access the array 344 to determine whether another command requires servicing. In a similar manner, the apparatus 300 services a command during each of times t2 and t3. However, at time t4, the ITR 348 selects a command, which includes an activity count greater than 16, for servicing. As described in steps 406-408, because the activity count of the command is greater than or equal to an activity threshold value (e.g., 16), the aging logic 352 updates the compare counter register value. More specifically, because the activity count initially increases to or past an activity count threshold (e.g., 16) after the compare counter register value was reset, the aging logic 352 updates the compare counter register value. For example, the compare counter register value is incremented to 16. Further, as described in steps 410-418, because the activity count of the command is not less than (e.g., is greater than or equal to) one-half (e.g., 8) the compare counter register value (e.g., 16), the selected command is serviced and the activity count for the command is updated. For example, the activity count for the command is incremented by 1.

As of time t4, the compare counter register value is 16. Therefore, the aging logic 352 does not service (e.g., blocks) a selected command, which includes an activity count less than 8. Commands with activity counts in the shaded area of FIG. 5 will not be serviced (e.g., are blocked) by the aging logic 352. For example, at time t6, the ITR 348 selects a command, which includes an activity count less than 8, for servicing. As described above, the aging logic 352 does not service the command.

At time t8, the ITR 348 selects a command, which includes an activity count greater than or equal to 32, for servicing. Because the activity count of the command is greater than or equal to an activity threshold value (e.g., 32), the aging logic 352 updates the compare counter register value. More specifically, because the activity count initially increases to or past another activity count threshold (e.g., 32) after the compare counter register value was reset, the aging logic 352 updates the compare counter register value. For example, the compare counter register value is incremented to 32. Further, because the activity count of the command is not less than (e.g., is greater than or equal to) one-half (e.g., 16) the compare counter register value (e.g., 32), the selected command is serviced and the activity count for the command is updated. For example, the activity count for the command is incremented by 1.

The apparatus 300 for aging commands continues to service commands in the manner described above until time t14. More specifically, the apparatus 300 for aging commands does not service commands, which include an activity count less than one-half of the compare counter register value and services commands with activity counts greater than or equal to one-half of the compare counter register value until time t14.

At time t14, the ITR 348 selects a command, which includes an activity count greater than or equal to 64, for servicing. Because the activity count of the command is greater than or equal to an activity threshold value (e.g., 64), the aging logic 352 updates the compare counter register value. More specifically, because the activity count initially increases to or past another activity count threshold (e.g., 64) after the compare counter register value was reset, the aging logic 352 updates the compare counter register value. For example, the compare counter register value is incremented to 64. Further, because the activity count of the command is not less than (e.g., is greater than or equal to) one-half (e.g., 32) the compare counter register value (e.g., 64), the selected command is serviced and the activity count for the command is updated. For example, the activity count for the command is incremented by 1. The apparatus 300 for aging commands continues to service commands in the manner described above until time t24.

At time t24, the ITR 348 selects a command, which includes an activity count greater than or equal to 128, for servicing. Because the activity count of the command is greater than or equal to an activity threshold value (e.g., 128), the aging logic 352 updates the compare counter register value. More specifically, because the activity count initially increases to or past another activity count threshold (e.g., 128) after the compare counter register value was reset, the aging logic 352 updates the compare counter register value. For example, the compare counter register value is incremented to 128. Further, because the activity count of the command is not less than (e.g., is greater than or equal to) one-half (e.g., 64) the compare counter register value (e.g., 128), the selected command is serviced and the activity count for the command is updated. For example, the activity count for the command is incremented by 1. The apparatus 300 continues to service commands in the manner described above until time t37. More specifically, the apparatus 300 for aging commands does not service commands, which include an activity count less than one-half of the compare counter register value and services commands greater than or equal to one-half of the compare counter register value until time t37.

At time t37, the ITR 348 selects a command, which includes an activity count greater than 64, for servicing. Because the activity count of the command is not less than (e.g., is greater than or equal to) one-half (e.g., 64) the compare counter register value (e.g., 128), the selected command is serviced. However, in contrast to the previously serviced commands, the command serviced at time t37 obtains a final required system resource (e.g., token). Therefore, the compare counter register value is reset (e.g., before time t38).

In this manner, the apparatus 300 may update the compare counter register value over time using graduated increments. For example, the aging logic 352 may update the compare counter register value from 16 to 32 to 64 to 128 over time, thereby preventing commands with activity counts less than 8, 16, 32 and 64, respectively, from being serviced. However, the aging logic 352 may update the compare counter register value differently over time. For example, as shown in FIG. 5, the aging logic 352 may increment the compare counter register value from 16 to 128. More specifically, at time t39, the ITR 348 selects a command, which includes an activity count greater than or equal to 16, for servicing. Because the activity count of the command is greater than or equal to an activity count threshold (e.g., 16), the aging logic 352 updates the compare counter register value. More specifically, because the activity count initially increases to or past an activity count threshold (e.g., 16) after the compare counter register value was reset (e.g., before time 38), the aging logic 352 updates the compare counter register value. For example, the compare counter register value is incremented to 16. At time t42, the ITR 348 selects a command, which includes an activity count greater than or equal to 128, for servicing. Because the activity count of the command is greater than or equal to another activity threshold value (e.g., 128), the aging logic 352 updates the compare counter register value. For example, the compare counter register value is incremented to 128.

In this manner, the present methods and apparatus efficiently service commands by favoring older commands over younger commands when necessary, thereby avoiding performance problems.

The foregoing description discloses only exemplary embodiments of the invention. Modifications of the above disclosed apparatus and methods which fall within the scope of the invention will be readily apparent to those of ordinary skill in the art. For instance, in one or more embodiments, the aging logic 352 increments the compare counter register value immediately after a command, which includes an activity count that initially increases to an activity count threshold after the compare counter register value was reset, is selected. However, in other embodiments, the aging logic 352 may wait a few time periods before incrementing the compare counter register value. In this manner, the aging logic 352 provides the apparatus 300 with additional time to service older commands before blocking younger commands. Further, the aging logic 352 may not block commands, which are entering the ITR 348 for the first time, from being serviced. In this manner, the first time a command is accessed by the ITR 348, the ITR 348 may make an initial request for a system resource (e.g., token) required by the command on behalf of the command. As stated above, the present methods and apparatus may be implemented in an apparatus 300 that implements Resource Allocation Groups (RAGs). In such embodiments, the aging provided by the aging logic 352 are confined to the RAG.

Further, commands described above may be from the same component of the computer system or from one or more different components (e.g., one or more third party chips 310-312) of the computer system.

Accordingly, while the present invention has been disclosed in connection with exemplary embodiments thereof, it should be understood that other embodiments may fall within the spirit and scope of the invention, as defined by the following claims.

The invention claimed is:

1. A method for servicing a command, comprising:
accessing an activity count corresponding to a command selected for servicing, wherein the activity count indicates a number of times the command has been selected for servicing;
based on the activity count, updating a blocking threshold value; and
determining whether to service the command based on the activity count and the blocking threshold value.

2. The method of claim 1 wherein updating the blocking threshold value includes incrementing the blocking threshold value when the activity count reaches or exceeds one of a plurality of activity count thresholds.

3. The method of claim 1 further comprising updating the activity count of the selected command.

4. The method of claim 3 wherein updating the activity count of the selected command includes incrementing the activity count.

5. The method of claim 1 further comprising resetting the blocking threshold value.

6. The method of claim 1 further comprising, if the activity count corresponding to the selected command is less than the blocking threshold value, blocking the selected command from servicing.

7. The method of claim 1 further comprising, if the activity count corresponding to the selected command is greater than or equal to the blocking threshold value, servicing the selected command.

8. An apparatus for servicing a command, comprising:
aging logic adapted to:
access an activity count corresponding to a command selected for servicing, wherein the activity count indicates a number of times the command has been selected for servicing;
based on the activity count, update a blocking threshold value; and
determine whether to service the command based on the activity count and the blocking threshold value.

9. The apparatus of claim 8 wherein the aging logic is further adapted to increment the blocking threshold value when the activity count reaches or exceeds one of a plurality of activity count thresholds.

10. The apparatus of claim 8 wherein the aging logic is further adapted to update the activity count of the selected command.

11. The apparatus of claim 10 wherein the aging logic is further adapted to increment the activity count.

12. The apparatus of claim 8 wherein the aging logic is further adapted to reset the blocking threshold value.

13. The apparatus of claim 8 wherein the aging logic is further adapted to, if the activity count corresponding to the selected command is less than the blocking threshold value, block the selected command from servicing.

14. The apparatus of claim 8 wherein the aging logic is further adapted to, if the activity count corresponding to the selected command is greater than or equal to the blocking threshold value, service the selected command.

15. The method of claim 1 wherein the activity count indicates a number of times the command has been selected for servicing but has not yet completed.

16. The apparatus of claim 8 wherein the activity count indicates a number of times the command has been selected for servicing but has not yet completed.
